(19) United States
(12) Patent Application Publication
(10) Pub. No.: US 2010/0105389 A1
(43) Pub. Date: Apr. 29, 2010

(54) METHODS AND SYSTEMS FOR PROACTIVE IDLE MODE HANDOFF

(75) Inventors: Tom Chin, San Diego, CA (US); Shan Qing, San Diego, CA (US); Kuo-Chun Lee, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/260,377

(22) Filed: Oct. 29, 2008

(51) Int. Cl. H04W 36/00

(52) U.S. Cl. 455/436

(57) ABSTRACT

Certain embodiments of the present disclosure provide a technique that allows a mobile station (MS) to proactively perform a handover during an idle mode. For example, during listening intervals of an idle mode, the MS may scan neighboring base stations (BSs) and proactively handover to a target BS. The MS may be able to synchronize frame numbers with the target BS before missing a page.

### TECHNICAL FIELD

Certain embodiments of the present disclosure generally relate to wireless communication and, more particularly, to idle mode handoff procedures.

### SUMMARY

Certain embodiments of the present disclosure provide a method for proactively switching between base stations in a wireless communications system. The method generally includes monitoring for paging messages from a current serving base station during a listening interval, determining, during the listening interval, if it would be beneficial to switch from the current serving base station to a neighboring base station, and proactively handing off to the neighboring base station if it is determined to be beneficial.

Certain embodiments of the present disclosure provide an apparatus for proactively switching between base stations in a wireless communications system. The apparatus generally includes logic for monitoring for paging messages from a current serving base station during a listening interval, logic for determining, during or at the end of the listening interval, if it would be beneficial to switch from the current serving base station to a neighboring base station, and logic for proactively handing off to the neighboring base station if it is determined to be beneficial.

Certain embodiments of the present disclosure provide an apparatus for proactively switching between base stations in a wireless communications system. The apparatus generally includes means for monitoring for paging messages from a current serving base station during a listening interval, means for determining, during or at the end of the listening interval, if it would be beneficial to switch from the current serving base station to a neighboring base station, and means for proactively handing off to the neighboring base station if it is determined to be beneficial.

Certain embodiments of the present disclosure provide a computer-program product for proactively switching between base stations in a wireless communications system comprising a computer readable medium having instructions stored thereon, the instructions being executable by one or more processors. The instructions generally include instructions for monitoring for paging messages from a current serving base station during a listening interval, instructions for determining, during or at the end of the listening interval, if it would be beneficial to switch from the current serving base station to a neighboring base station, and instructions for proactively handing off to the neighboring base station if it is determined to be beneficial.

In certain embodiments, as disclosed herein, the base station(s) may communicate in accordance with one or more standards of the Institute of Electrical and Electronics Engineers (IEEE) 802.16 family of standards.

### BRIEF DESCRIPTION OF THE DRAWINGS

So that the manner in which the above-recited features of the present disclosure can be understood in detail, a more particular description, briefly summarized above, may be had by reference to embodiments, some of which are illustrated in the appended drawings. It is to be noted, however, that the appended drawings illustrate only certain typical embodiments of this disclosure and are therefore not to be considered limiting of its scope, for the description may admit to other equally effective embodiments.

FIG. 1 illustrates an example wireless communication system, in accordance with certain embodiments of the present disclosure.

FIG. 2 illustrates various components that may be utilized in a wireless device in accordance with certain embodiments of the present disclosure.

FIG. 3 illustrates an example transmitter and an example receiver in accordance with certain embodiments of the present disclosure.

FIGS. 4A and 4B illustrate example exchanges between a mobile station in an idle mode and two base stations.

FIG. 5 illustrates example operations for proactively performing an idle mode handoff, in accordance with embodiments of the present disclosure.

FIG. 5A is a block diagram of components capable of performing the example operations shown in FIG. 5.

### DETAILED DESCRIPTION

Mobile WiMAX standards define an idle mode during which a mobile station (MS) may power down components in an effort to conserve power. In the idle mode, the MS powers up components to monitor for page messages in recurring MS Paging Listening (“listening”) intervals, while powering down components in MS Paging Unavailable (“sleep”) intervals.

In a mobile WiMAX network, each WiMAX frame has a 24-bit frame number that increments every frame until the maximum is reached before restarting from zero. This frame number can be used to decide when a Base Station (BS) should send a BS Broadcast Paging (MOB_PAG-ADV) message, at some Paging_Offset within a periodic Paging_Cycle. To synchronize with the paging cycle of a BS, the MS may start to listen for the MOB_PAG-ADV message from frame number N when:

Nmod Paging_Cycle=Paging_Offset (1)

Unfortunately, the frame number of each WiMAX BS may not be synchronous, meaning different BSs may have different frame numbers at any instance. This means that, according to Equation (1), the paging cycles of each BS may occur at different points in time. As a result, in the event an MS hands over from a current serving BS to a new BS (e.g., just after a paging interval of the new BS), the MS may miss a page message, resulting in increased call setup delay.

Certain embodiments of the present disclosure provide a technique that allows a WiMAX mobile station (MS) to proactively perform a handover during an idle mode. For example, during listening intervals of an idle mode, the MS may scan neighboring base stations (BSs) and proactively handover to a target BS if it is determined to be beneficial (e.g., if the target BS has a greater signal strength than a current serving BS and/or the signal strength of the current serving BS has fallen below a threshold value). As a result, the MS may be able to synchronize frame numbers with the target BS before missing a page.

### Exemplary Wireless Communication System

The methods and apparatus of the present disclosure may be utilized in a broadband wireless communication system. As used herein, the term “broadband wireless” generally refers to technology that may provide any combination of wireless services, such as voice, Internet and/or data network access over a given area.

WiMAX, which stands for the Worldwide Interoperability for Microwave Access, is a standards-based broadband wireless technology that provides high-throughput broadband connections over long distances. There are two main applications of WiMAX today: fixed WiMAX and mobile WiMAX. Fixed WiMAX applications are point-to-multipoint, enabling broadband access to homes and businesses, for example. Mobile WiMAX offers the full mobility of cellular networks at broadband speeds.

Mobile WiMAX is based on OFDM (orthogonal frequency-division multiplexing) and OFDMA (orthogonal frequency division multiple access) technology. OFDM is a digital multi-carrier modulation technique that has recently found wide adoption in a variety of high-data-rate communication systems. With OFDM, a transmit bit stream is divided into multiple lower-rate substreams. Each substream is modulated with one of multiple orthogonal subcarriers and sent over one of a plurality of parallel subchannels. OFDMA is a multiple access technique in which users are assigned subcarriers in different time slots. OFDMA is a flexible multiple-access technique that can accommodate many users with widely varying applications, data rates, and quality of service requirements.

The rapid growth in wireless internets and communications has led to an increasing demand for high data rate in the field of wireless communications services. OFDM/OFDMA systems are today regarded as one of the most promising research areas and as a key technology for the next generation of wireless communications. This is due to the fact that OFDM/OFDMA modulation schemes can provide many advantages such as modulation efficiency, spectrum efficiency, flexibility, and strong multipath immunity over conventional single carrier modulation schemes.

IEEE 802.16x is an emerging standard organization to define an air interface for fixed and mobile broadband wireless access (BWA) systems. These standards define at least four different physical layers (PHYs) and one media access control (MAC) layer. The OFDM and OFDMA physical layer of the four physical layers are the most popular in the fixed and mobile BWA areas respectively.

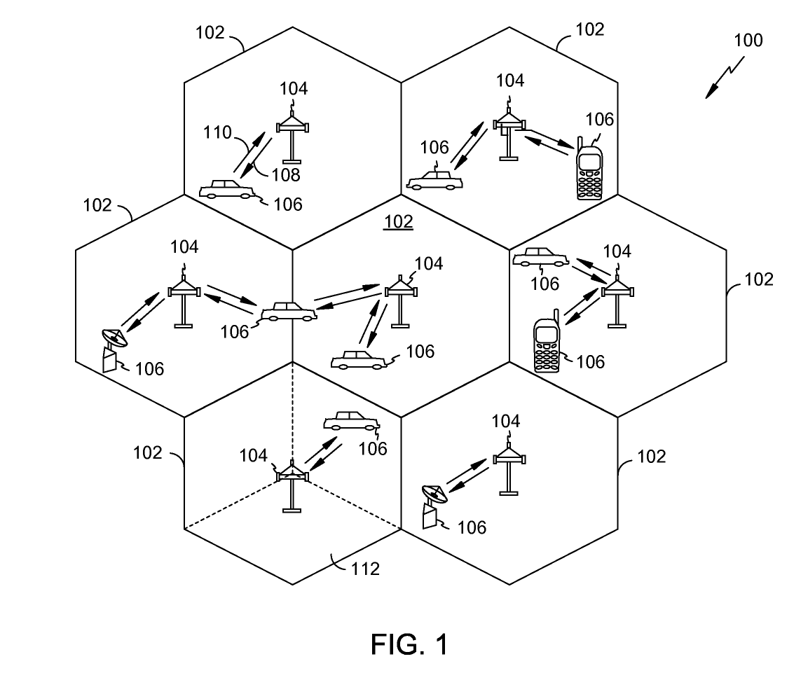

FIG. 1 illustrates an example of a wireless communication system 100 in which embodiments of the present disclosure may be employed. The wireless communication system 100 may be a broadband wireless communication system. The wireless communication system 100 may provide communication for a number of cells 102, each of which is serviced by a base station 104. A base station 104 may be a fixed station that communicates with user terminals 106. The base station 104 may alternatively be referred to as an access point, a Node B, or some other terminology.

FIG. 1 depicts various user terminals 106 dispersed throughout the system 100. The user terminals 106 may be fixed (i.e., stationary) or mobile. The user terminals 106 may alternatively be referred to as remote stations, access terminals, terminals, subscriber units, mobile stations, stations, user equipment, etc. The user terminals 106 may be wireless devices, such as cellular phones, personal digital assistants (PDAs), handheld devices, wireless modems, laptop computers, personal computers, etc.

A variety of algorithms and methods may be used for transmissions in the wireless communication system 100 between the base stations 104 and the user terminals 106. For example, signals may be sent and received between the base stations 104 and the user terminals 106 in accordance with OFDM/OFDMA techniques. If this is the case, the wireless communication system 100 may be referred to as an OFDM/OFDMA system.

A communication link that facilitates transmission from a base station 104 to a user terminal 106 may be referred to as a downlink 108, and a communication link that facilitates transmission from a user terminal 106 to a base station 104 may be referred to as an uplink 1 10. Alternatively, a downlink 108 may be referred to as a forward link or a forward channel, and an uplink 110 may be referred to as a reverse link or a reverse channel.

A cell 102 may be divided into multiple sectors 112. A sector 112 is a physical coverage area within a cell 102. Base stations 104 within a wireless communication system 100 may utilize antennas that concentrate the flow of power within a particular sector 112 of the cell 102. Such antennas may be referred to as directional antennas.

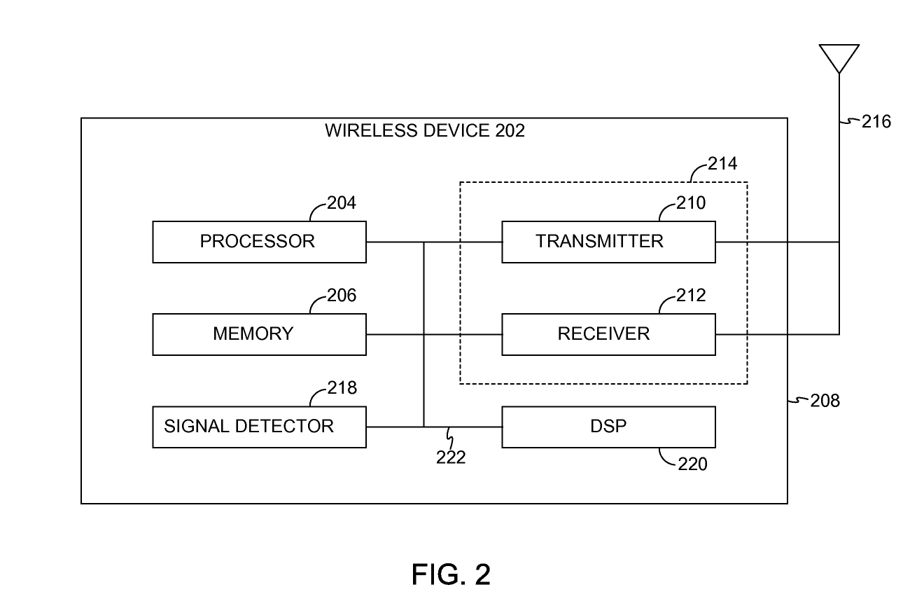

FIG. 2 illustrates various components that may be utilized in a wireless device 202 that may be employed within the wireless communication system 100. The wireless device 202 is an example of a device that may be configured to implement the various methods described herein. The wireless device 202 may be a base station 104 or a user terminal 106.

The wireless device 202 may include a processor 204 which controls operation of the wireless device 202. The processor 204 may also be referred to as a central processing unit (CPU). Memory 206, which may include both read-only memory (ROM) and random access memory (RAM), provides instructions and data to the processor 204. A portion of the memory 206 may also include non-volatile random access memory (NVRAM). The processor 204 typically performs logical and arithmetic operations based on program instructions stored within the memory 206. The instructions in the memory 206 may be executable to implement the methods described herein.

The wireless device 202 may also include a housing 208 that may include a transmitter 210 and a receiver 212 to allow transmission and reception of data between the wireless device 202 and a remote location. The transmitter 210 and receiver 212 may be combined into a transceiver 214. An antenna 216 may be attached to the housing 208 and electrically coupled to the transceiver 214. The wireless device 202 may also include (not shown) multiple transmitters, multiple receivers, multiple transceivers, and/or multiple antennas.

The wireless device 202 may also include a signal detector 218 that may be used in an effort to detect and quantify the level of signals received by the transceiver 214. The signal detector 218 may detect such signals as total energy, pilot energy per subcarrier and per symbol, power spectral density and other signals. The wireless device 202 may also include a digital signal processor (DSP) 220 for use in processing signals.

The various components of the wireless device 202 may be coupled together by a bus system 222, which may include a power bus, a control signal bus, and a status signal bus in addition to a data bus.

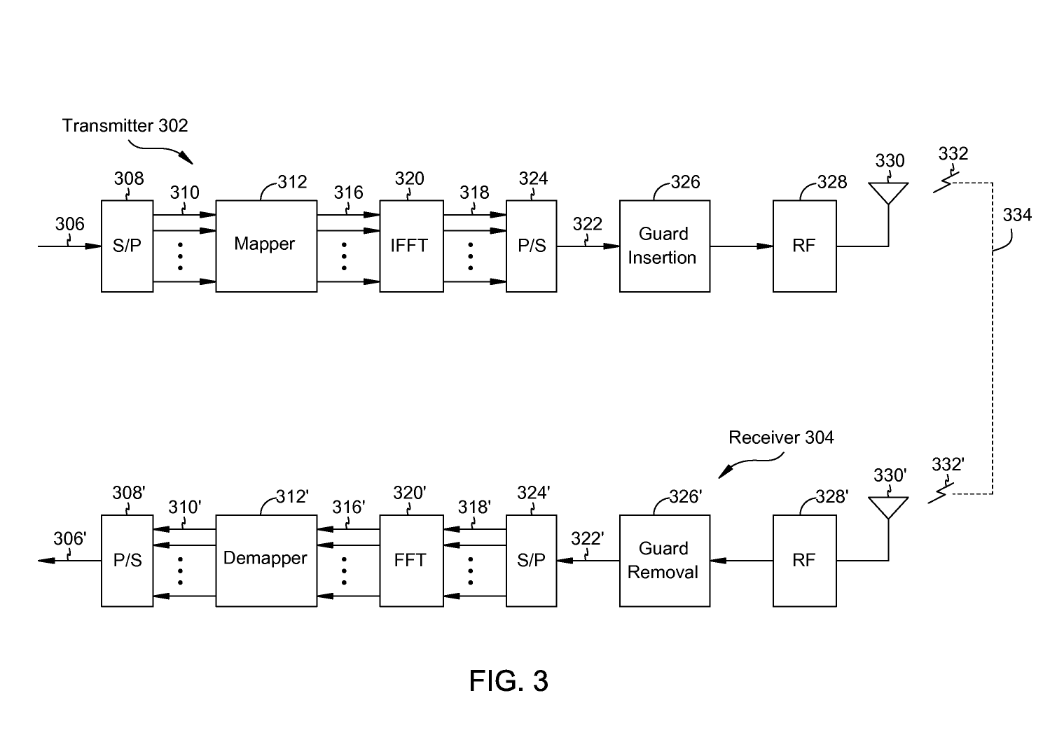

FIG. 3 illustrates an example of a transmitter 302 that may be used within a wireless communication system 100 that utilizes OFDM/OFDMA. Portions of the transmitter 302 may be implemented in the transmitter 210 of a wireless device 202. The transmitter 302 may be implemented in a base station 104 for transmitting data 306 to a user terminal 106 on a downlink 108. The transmitter 302 may also be implemented in a user terminal 106 for transmitting data 306 to a base station 104 on an uplink 110.

Data 306 to be transmitted is shown being provided as input to a serial-to-parallel (S/P) converter 308. The S/P converter 308 may split the transmission data into N parallel data streams 310.

The N parallel data streams 310 may then be provided as input to a mapper 312. The mapper 312 may map the N parallel data streams 310 onto N constellation points. The mapping may be done using some modulation constellation, such as binary phase-shift keying (BPSK), quadrature phase-shift keying (QPSK), 8 phase-shift keying (8PSK), quadrature amplitude modulation (QAM), etc. Thus, the mapper 312 may output N parallel symbol streams 316, each symbol stream 316 corresponding to one of the N orthogonal subcarriers of the inverse fast Fourier transform (IFFT) 320. These N parallel symbol streams 316 are represented in the frequency domain and may be converted into N parallel time domain sample streams 318 by an IFFT component 320.

A brief note about terminology will now be provided. N parallel modulations in the frequency domain are equal to N modulation symbols in the frequency domain, which are equal to N mapping and N-point IFFT in the frequency domain, which is equal to one (useful) OFDM symbol in the time domain, which is equal to N samples in the time domain. One OFDM symbol in the time domain, Ns, is equal to Ncp (the number of guard samples per OFDM symbol)+N (the number of useful samples per OFDM symbol).

The N parallel time domain sample streams 318 may be converted into an OFDM/OFDMA symbol stream 322 by a parallel-to-serial (P/S) converter 324. A guard insertion component 326 may insert a guard interval between successive OFDM/OFDMA symbols in the OFDM/OFDMA symbol stream 322. The output of the guard insertion component 326 may then be upconverted to a desired transmit frequency band by a radio frequency (RF) front end 328. An antenna 330 may then transmit the resulting signal 332.

FIG. 3 also illustrates an example of a receiver 304 that may be used within a wireless device 202 that utilizes OFDM/OFDMA. Portions of the receiver 304 may be implemented in the receiver 212 of a wireless device 202. The receiver 304 may be implemented in a user terminal 106 for receiving data 306 from a base station 104 on a downlink 108. The receiver 304 may also be implemented in a base station 104 for receiving data 306 from a user terminal 106 on an uplink 110.

The transmitted signal 332 is shown traveling over a wireless channel 334. When a signal 332′ is received by an antenna 330′, the received signal 332′ may be downconverted to a baseband signal by an RF front end 328′. A guard removal component 326′ may then remove the guard interval that was inserted between OFDM/OFDMA symbols by the guard insertion component 326.

The output of the guard removal component 326′ may be provided to an S/P converter 324′. The S/P converter 324′ may divide the OFDM/OFDMA symbol stream 322′ into the N parallel time-domain symbol streams 318′, each of which corresponds to one of the N orthogonal subcarriers. A fast Fourier transform (FFT) component 320′ may convert the N parallel time-domain symbol streams 318′ into the frequency domain and output N parallel frequency-domain symbol streams 316′.

A demapper 312′ may perform the inverse of the symbol mapping operation that was performed by the mapper 312 thereby outputting N parallel data streams 310′. A P/S converter 308′ may combine the N parallel data streams 310′ into a single data stream 306′. Ideally, this data stream 306′ corresponds to the data 306 that was provided as input to the transmitter 302. Note that elements 308′, 310′, 312′, 316′, 320′, 318′ and 324′ may all be found on a in a baseband processor 340′.

### Exemplary Proactive Idle Mode Handoff

Mobile WiMAX standards define an idle mode during which a mobile station (MS) may power down components in an effort to conserve power. In the idle mode, the MS powers up components to monitor for page messages in recurring MS Paging Listening (“listening”) intervals, while powering down components in MS Paging Unavailable (“sleep”) intervals. During the recurring listening intervals, the MS monitors for BS Broadcast Paging (MOB_PAG-ADV) messages.

Prior to entering the idle mode, the MS may negotiate deregistration with a serving BS. During the deregistration negotiation, the MS and BS may exchange idle mode parameters, enabling the synchronization of MS listening intervals with BS paging intervals. The idle mode parameters may include, for example, a listening cycle which may be MS specific, a paging offset which may be MS specific, the frame number of the BS, and a frame number N at which the MS may start listening for the MOB_PAG-ADV message.

In accordance with Equation (1) above, the frame number N at which the MS may start listening for the MOB_PAG-ADV message, may be determined such that the remainder of the quotient of the frame number N divided by the number of frames in a paging cycle equals a paging offset (N mod Paging_Cycle), where the paging offset is the frame within the paging cycle in which the paging message is transmitted by the BS, according to Equation (1) above.

When a local network receives data traffic destined for an MS in idle mode, an access service network gateway (ASN-GW) may instruct all of the BSs in an associated paging group to broadcast a MOB_PAG-ADV message containing an indication the MS is being paged. Because frame numbers are not typically synchronized across BSs, the paging intervals of different BSs in the same paging group may occur at different points in time.

Unfortunately, this creates an opportunity where an MS may miss a paging message when moving from an old BS to a new BS in idle mode. For example, if the MS wakes up to find it has lost connection with a current serving BS, it may miss a page from the current serving BS. Worse, the MS may not complete the handoff procedure until after the paging interval of the new BS. Thus, the BS may miss two page messages before finally receiving a page message in a subsequent paging interval of the new BS.

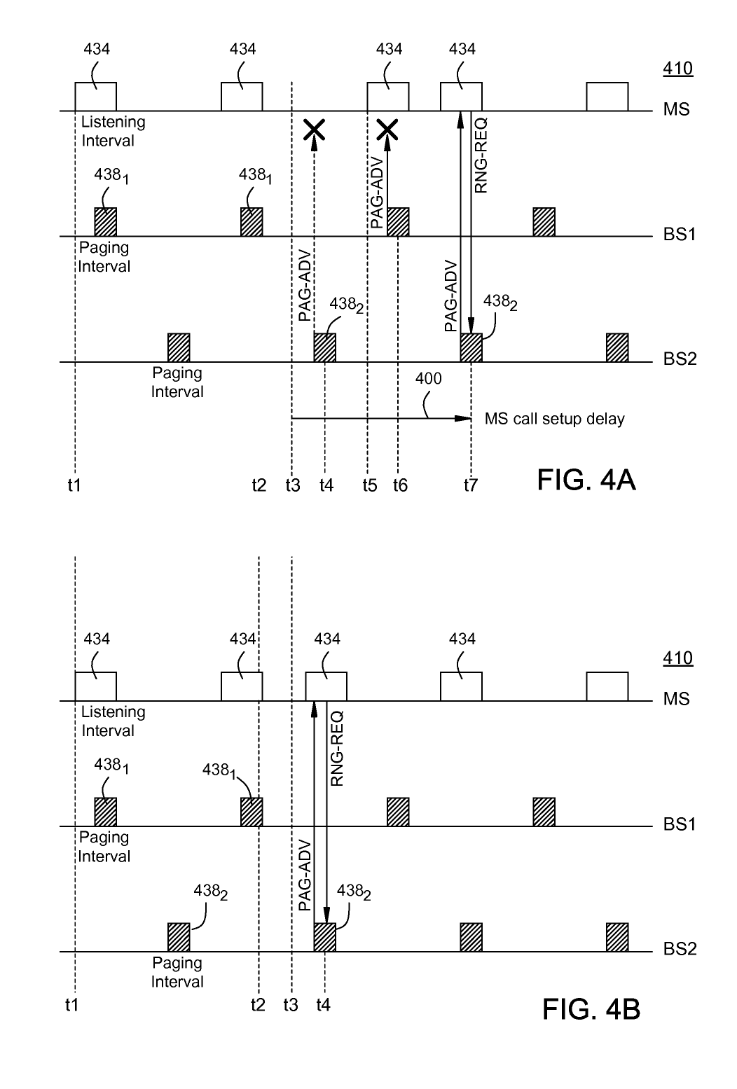

FIG. 4A illustrates such a scenario where an MS 410 moves from a current serving BS (BS1) to a new BS (BS2). The illustrated example assumes that the MS enters the idle mode at time t1. Thus, the (MS Paging) Listening Intervals 434 of the MS are aligned with the paging intervals 4381 of BS1.

As illustrated, however, the paging intervals 4381 of BS1 are not synchronized with the paging intervals 4382 of BS2. Thus, in this example, when a page request arises in the network at t3, BS2 sends a MOB_PAG-ADV message before BS1. Because the MS is synchronized to BS1 and is still asleep during the paging interval 4382 of BS2, the MS does not hear the paging message sent from BS2 (as indicated by the “X”). Further, the illustrated example also assumes that by time t5, the MS has lost connection with BS1 (e.g., the signal quality of BS1 has degraded). Therefore, when the MS wakes up at t5, it also does not hear the paging message sent from BS1 at time t6.

After detecting the loss of connection with BS1, the MS may determine (by a BS scan) that it is in the coverage area of BS2. The MS may then handoff to BS2, synchronize with the BS2 frame numbers, and finally receive a page message from BS2 at t7. As illustrated, this scenario with two missed paging messages results in a rather lengthy call setup delay 400 from the initial time t3 of the initial network page request.

Embodiments of the present disclosure, however, may help avoid this scenario and help avoid unnecessary delay in receiving and responding to paging messages through the use of proactive handoff in idle mode. In the techniques presented herein, an MS in idle mode may scan neighboring BSs during a listening interval and proactively switch to a neighbor BS with better signal strength or signal quality. This proactive idle handoff procedure differs from the typical handoff procedure in which an MS will attempt to acquire a new BS only when the MS loses contact with the old BS in the beginning of the paging interval.

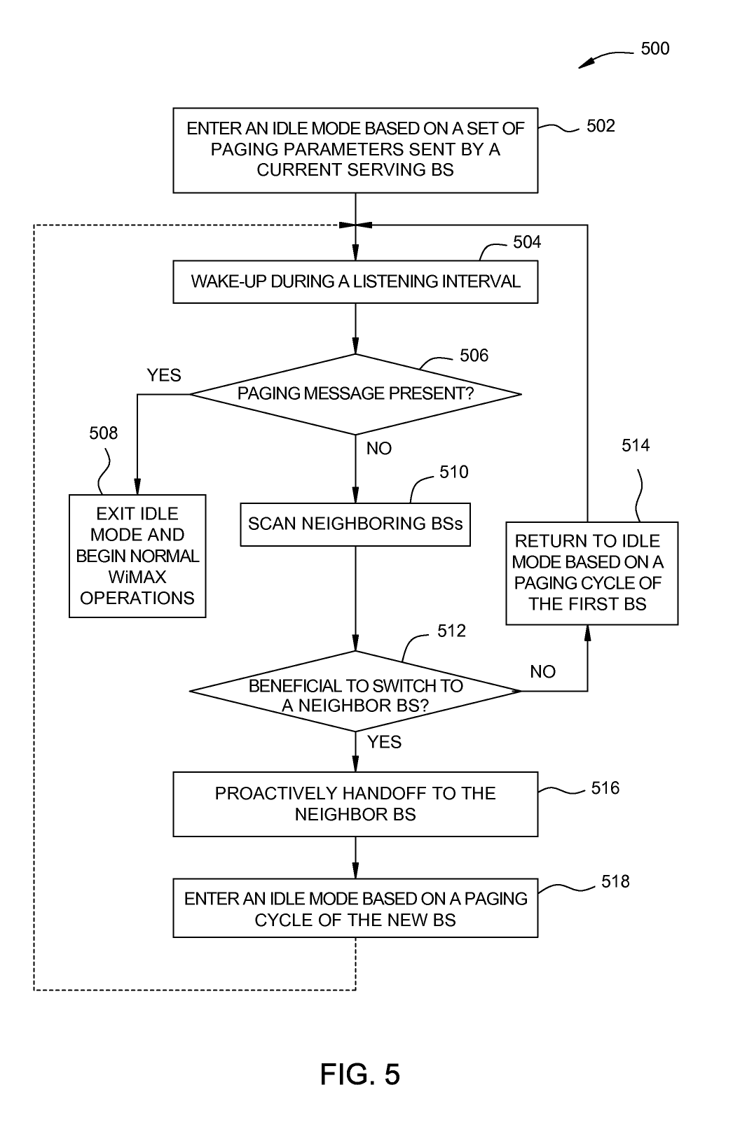

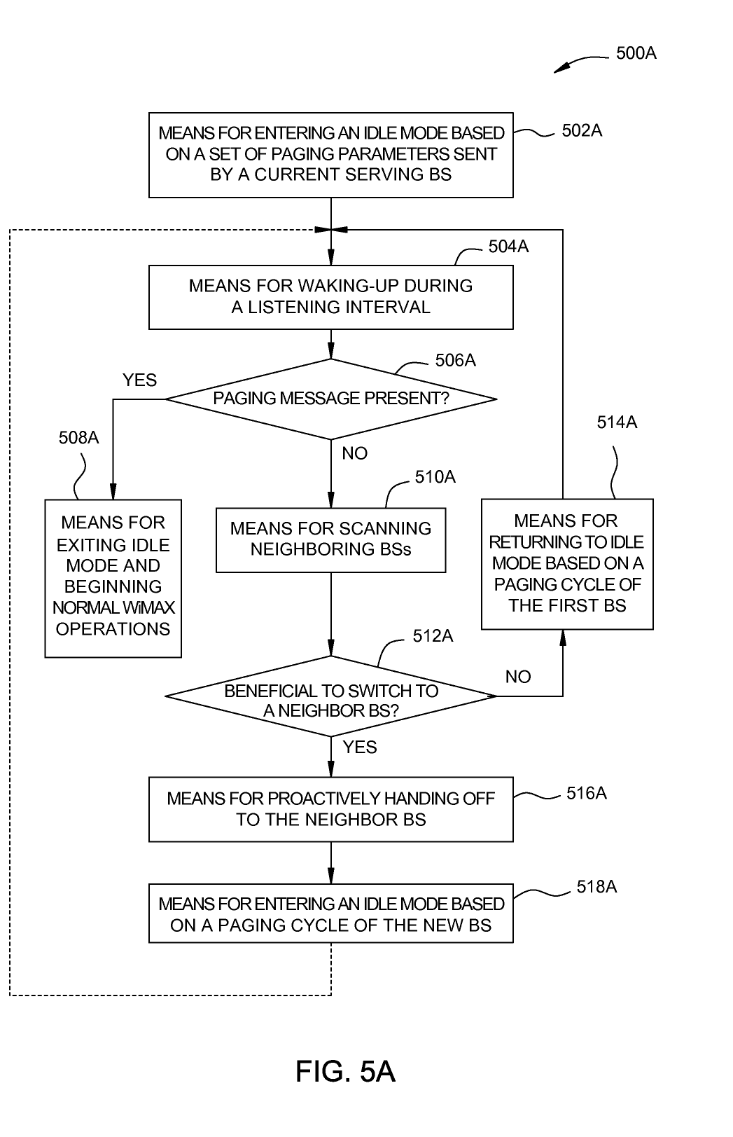

FIG. 5 illustrates example operations 500 that an MS may perform for performing proactive handoff operations in idle mode, in accordance with certain embodiments of the present disclosure. The operations may be described with reference to the example exchange of messages shown in FIG. 4B.

The operations begin, at 502, by entering an idle mode with a current serving BS. As illustrated in FIG. 4B, at time t1, MS 410 may enter an idle mode with current serving BS1.

At 504, the MS wakes up during a listening interval to check for a paging message. If a paging message is present, as determined at 506, the MS may exit idle mode, at 508 (e.g., and begin a WiMAX data exchange).

If a paging message is not present, however, rather than go directly back to sleep, after performing standard idle mode processing in the listening interval (e.g., monitoring for a paging message from the serving BS) the MS may scan neighbor BSs, at 5 10. This neighbor BS scan may be performed during the listening interval or at the end of the listening interval (e.g., after determining there is no paging message from a current serving BS). If the MS determines, at 512, that it is not beneficial to switch to a neighbor BS based on results of the scan, the MS may simply return to the idle mode, at 514, and proceed to the next sleep interval.

On the other hand, if the MS determines that it is beneficial to switch to a neighbor BS, the MS may proactively handoff to the neighbor BS, at 516. Once synchronized with the neighbor BS, the MS may enter an idle mode based on the paging cycle of the new serving (neighbor) BS, at 518.

This proactive handoff is illustrated in FIG. 4B, where the MS determines that it is beneficial to switch from BS1 to BS2, at time t2 during a listening interval 434. Because of this proactive handoff, the MS may already be synchronized with BS2 when the network receives a page request at t3. As a result, the MS is able to hear the paging message sent from BS2 in the first paging interval 4382, thereby avoiding the lengthy call setup delay 400 of FIG. 4A caused by missing two page messages. The MS may reply using standing ranging procedures and proceed in accordance with the page message.

An MS may utilize any suitable algorithm when deciding whether or not it is beneficial to proactively handoff to a neighbor base station. For example, for certain embodiments, the MS may look to handover to a neighbor BS after a signal quality parameter of the current serving BS, such as received signaling strength (RSSI) or carrier to interference and noise ratio (CINR), is less than the threshold U value. Depending on the embodiment, the MS may perform a scan of neighboring base stations only when the signal quality parameter is below the threshold value and may otherwise save the processing overhead. For certain embodiments, the MS can utilize the information in a neighbor broadcast message (MOB_NBR-ADV) sent by the serving BS to speed up scanning for other BSs.

Various algorithms may be used to determine when to proactively switch to a neighbor BS based on relative signal quality of a current serving BS and neighbor BSs. For certain embodiments, an MS may decide to switch if RSSI and/or CINR of a neighbor BS is more than that of the current serving BS:

RSSINEIGHBOR>RSSISERVING

For certain embodiments, an MS may decide to switch if RSSI and/or CINR of the neighbor BS is more than that of the current BS by a threshold margin D.

RSSINEIGHBOR>RSSISERVING+D

For certain embodiments, an MS may perform a neighbor BS scan during multiple listening intervals before deciding to handoff. In such cases, an MS only decide to switch if RSSI and/or CINR of the neighbor BS is more than that of the current BS continuously for K paging intervals (where K>1) in order to ensure a handoff will be beneficial.

Regardless of how the decision to proactively handoff is made, once the MS decides to switch to the neighbor BS, the MS will synchronize to the DL frame and decode the DL MAP message from the new BS. From the DL MAP message, the MS will receive frame number of the new BS and will use this new frame number to update its local frame number counter in order to synchronize its listening intervals with the paging intervals of the new BS.

For certain embodiments, the MS may also need to receive DCD (Downlink Channel Descriptor) and UCD (Uplink Channel Descriptor) messages in order to acquire the system configuration. From the DCD and UCD messages, the MS may also learn whether the new BS belongs to the same paging group of the old BS or not. If the new BS is in the different paging group, then the MS may perform the location update procedure so it can be reached. In any case, once proactive idle handoff completes, the MS may again enter an idle mode according to the paging schedule of the new BS.

The various operations of methods described above may be performed by various hardware and/or software component(s) and/or module(s) corresponding to means-plus-function blocks illustrated in the Figures. Generally, where there are methods illustrated in Figures having corresponding counterpart means-plus-function Figures, the operation blocks correspond to means-plus-function blocks with similar numbering. For example, blocks 502-518 illustrated in FIG. 5 correspond to means-plus-function blocks 502A-518A illustrated in FIG. 5A.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

Information and signals may be represented using any of a variety of different technologies and techniques. For example, data, instructions, commands, information, signals and the like that may be referenced throughout the above description may be represented by voltages, currents, electromagnetic waves, magnetic fields or particles, optical fields or particles or any combination thereof.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device, discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core or any other such configuration.

The steps of a method or algorithm described in connection with the present disclosure may be embodied directly in hardware, in a software module executed by a processor or in a combination of the two. A software module may reside in any form of storage medium that is known in the art. Some examples of storage media that may be used include RAM memory, flash memory, ROM memory, EPROM memory, EEPROM memory, registers, a hard disk, a removable disk, a CD-ROM and so forth. A software module may comprise a single instruction, or many instructions, and may be distributed over several different code segments, among different programs and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein, such as those illustrated in the Figures, can be downloaded and/or otherwise obtained by a mobile device and/or base station as applicable. For example, such a device can be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a mobile device and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to certain embodiments of the present disclosure, other and further embodiments may be devised without departing from the basic scope thereof, and the scope thereof is determined by the claims that follow.

What is claimed is:

1. A method for proactively switching between base stations in a wireless communications system, comprising:
monitoring for paging messages from a current serving base station during a listening interval;
determining, during or at the end of the listening interval, if it would be beneficial to switch from the current serving base station to a neighboring base station; and
proactively handing off to the neighboring base station if it is determined to be beneficial.

2. The method of claim 1, wherein determining if it would be beneficial to switch from the current serving base station to a neighboring base station comprises:
determining if a signal quality parameter of the current serving base station has fallen below a threshold value.

3. The method of claim 1, wherein determining if it would be beneficial to switch from the current serving base station to a neighboring base station comprises:
performing a scan of neighboring base stations to obtain signal quality parameters for the neighbor base stations; and
comparing at least one signal quality parameter of the current serving base station to at least one signal quality parameter of the neighboring base stations.

4. The method of claim 1, further comprising:
continuing the idle mode after proactively handing off to the neighboring base station.

5. The method of claim 1, further comprising:
detecting a paging message from the current serving base station during the listening interval; and
exiting the idle mode in response to the paging message.

6. The method of claim 1, wherein proactively handing off to the neighboring base station comprises:
synchronizing a local frame number counter with a frame number of the neighboring base station; and
entering an idle mode with listening intervals synchronized with paging intervals of the neighboring base station.

7. The method of claim 6, wherein proactively handing off to the neighboring base station further comprises:
decoding a downlink channel descriptor (DCD) message to determine a paging group of the neighboring base station; and
performing a location update procedure if the neighboring base station belongs to a different paging group than the current serving base station.

8. An apparatus for proactively switching between base stations in a wireless communications system, comprising:
logic for monitoring for paging messages from a current serving base station during a listening interval;
logic for determining, during or at the end of the listening interval, if it would be beneficial to switch from the current serving base station to a neighboring base station; and
logic for proactively handing off to the neighboring base station if it is determined to be beneficial.

9. The apparatus of claim 8, wherein the logic for determining if it would be beneficial to switch from the current serving base station to a neighboring base is configured to determine if a signal quality parameter of the current serving base station has fallen below a threshold value.

10. The apparatus of claim 8, wherein the logic for determining if it would be beneficial to switch from the current serving base station to a neighboring base station comprises:
logic for performing a scan of neighboring base stations to obtain signal quality parameters for the neighbor base stations; and
logic for comparing at least one signal quality parameter of the current serving base station to at least one signal quality parameter of the neighboring base stations.

11. The apparatus of claim 8, further comprising:
logic for continuing the idle mode after proactively handing off to the neighboring base station.

12. The apparatus of claim 8, further comprising:
logic for detecting a paging message from the current serving base station during the listening interval; and
logic for exiting the idle mode in response to the paging message.

13. The apparatus of claim 8, wherein the logic for proactively handing off to the neighboring base station is configured to:
synchronize a local frame number counter with a frame number of the neighboring base station; and
enter an idle mode with listening intervals synchronized with paging intervals of the neighboring base station.

14. The apparatus of claim 13, wherein the logic for proactively handing off to the neighboring base station comprises:
logic for decoding a downlink channel descriptor (DCD) message to determine a paging group of the neighboring base station; and
logic for performing a location update procedure if the neighboring base station belongs to a different paging group than the current serving base station.

15. An apparatus for proactively switching between base stations in a wireless communications system, comprising:
means for monitoring for paging messages from a current serving base station during a listening interval;
means for determining, during or at the end of the listening interval, if it would be beneficial to switch from the current serving base station to a neighboring base station; and
means for proactively handing off to the neighboring base station if it is determined to be beneficial.

16. The apparatus of claim 15, wherein the means for determining if it would be beneficial to switch from the current serving base station to a neighboring base station is configured to determine if a signal quality parameter of the current serving base station has fallen below a threshold value.

17. The apparatus of claim 15, wherein the means for determining if it would be beneficial to switch from the current serving base station to a neighboring base station comprises:
means for performing a scan of neighboring base stations to obtain signal quality parameters for the neighbor base stations; and
means for comparing at least one signal quality parameter of the current serving base station to at least one signal quality parameter of the neighboring base stations.

18. The apparatus of claim 15, further comprising:
means for continuing the idle mode after proactively handing off to the neighboring base station.

19. The apparatus of claim 15, further comprising:
means for detecting a paging message from the current serving base station during the listening interval; and
means for exiting the idle mode in response to the paging message.

20. The apparatus of claim 15, wherein the means for proactively handing off to the neighboring base station is configured to:
synchronize a local frame number counter with a frame number of the neighboring base station; and
enter an idle mode with listening intervals synchronized with paging intervals of the neighboring base station.

21. The apparatus of claim 20, wherein the means for proactively handing off to the neighboring base station comprises:
means for decoding a downlink channel descriptor (DCD) message to determine a paging group of the neighboring base station; and
means for performing a location update procedure if the neighboring base station belongs to a different paging group than the current serving base station.

22. A computer-program product for proactively switching between base stations in a wireless communications system, comprising a computer readable medium having instructions stored thereon, the instructions being executable by one or more processors and the instructions comprising:
instructions for monitoring for paging messages from a current serving base station during a listening interval;
instructions for determining, during or at the end of the listening interval, if it would be beneficial to switch from the current serving base station to a neighboring base station; and
instructions for proactively handing off to the neighboring base station if it is determined to be beneficial.

23. The computer-program product of claim 22, wherein the instructions for determining if it would be beneficial to switch from the current serving base station to a neighboring base station comprise:
instructions for determining if a signal quality parameter of the current serving base station has fallen below a threshold value.

24. The computer-program product of claim 22, wherein the instructions for determining if it would be beneficial to switch from the current serving base station to a neighboring base station comprise:
instructions for performing a scan of neighboring base stations to obtain signal quality parameters for the neighbor base stations; and
instructions for comparing at least one signal quality parameter of the current serving base station to at least one signal quality parameter of the neighboring base stations.

25. The computer-program product of claim 22, wherein the instructions further comprise:
instructions for continuing the idle mode after proactively handing off to the neighboring base station.

26. The computer-program product of claim 22, wherein the instructions further comprise:
instructions for detecting a paging message from the current serving base station during the listening interval; and
instructions for exiting the idle mode in response to the paging message.

27. The computer-program product of claim 22, wherein the instructions for proactively handing off to the neighboring base station comprise:
instructions for synchronizing a local frame number counter with a frame number of the neighboring base station; and
instructions for entering an idle mode with listening intervals synchronized with paging intervals of the neighboring base station.

28. The computer-program product of claim 27, wherein the instructions for proactively handing off to the neighboring base station further comprise:
instructions for decoding a downlink channel descriptor (DCD) message to determine a paging group of the neighboring base station; and
instructions for performing a location update procedure if the neighboring base station belongs to a different paging group than the current serving base station.
